(19) United States
(12) Patent Application Publication
(10) Pub. No.: US 2009/0289396 A1
(43) Pub. Date: Nov. 26, 2009

(54) PROCESSING OF PARTICULATE MATERIALS, RECYCLING METHODS, ESPECIALLY FOR RUBBER

(76) Inventor: Ian Walters, Briton Ferry South Wales (GB)

Correspondence Address: FAY SHARPE LLP, 1228 Euclid Avenue, 5th Floor, The Halle Building, Cleveland, OH, 44115, US

(21) Appl. No.: 12/377,209

(22) PCT Filed: Sep. 4, 2006
(86) PCT No.: PCT/GB2006/003253

§ 371 Date: Aug. 11, 2009

(30) Foreign Application Priority Data
Sep. 2, 2005 (GB) 0517999.9
Aug. 14, 2006 (GB) 0616188.9

(51) Int. Cl. B29C 39/00; H05H 1/26

(52) U.S. Cl. 264/483; 264/299; 264/310

(57) ABSTRACT

A method for recycling polymeric materials, particularly cured rubber such as may be derived from tyres and the like, includes obtaining solid polymer material in particulate form derived from a previous artifact or product. The polymer particles are exposed to a fluid treatment medium which chemically modifies the particle surfaces to provide chemically activated particle surfaces, while maintaining polymer properties in the particle interiors. The surface activated polymer particles are combined with a flowable binder or matrix material. The binder or matrix material is then cured, dried or set in intimate contact with the surface-activated polymer particles to form a body of material incorporating the recycled polymer particles with the surfaces bonded to the cured, dried or set binder or matrix material. In this way, large proportions of particulate material can be recycled into new products which exhibit good performance, e.g. elastomeric performance.

This invention has to do the processing of particulate materials, especially for recycling. In particular embodiments, it relates to surface modification of particulate rubber materials as part of a process of recycling spent or waste products such as tyres or mats, with a view to their being incorporated into new products, e.g. as fillers, reinforcement, or extenders dispersed in a matrix binder material such as a first-use uncured rubber, for curing to form new and useful products.

### BACKGROUND

The interest in effectively recycling material increases year on year, driven by the need to reduce the accumulation of waste and to slow the consumption of scarce natural resources. As the use of recycling grows in mainstream commercial products, the desire to ensure good service performance in products containing recycled material increases correspondingly.

For many years within the rubber industry there has been an ongoing interest in being able to re-use waste rubber, particularly from vehicle tyres since these represent an enormous volume of material. It has been a practice to strip the rubber from waste tyres and grind it down into particles. These particles (granules, crumb and dust) of recycled cured rubber have typically been combined with some kind of binder material to form a processable blend which is shaped into new rubber articles. This achieves recycling, but as a generality the new articles have much lower performance, in terms of elastic properties and physical strength, than the original cured rubber and are correspondingly limited in use to simple ‘static’ applications.

Numerous proposals have been made to improve the re-usability of recycled rubber particles, and/or to improve the performance of products made from them. See for example U.S. Pat. No. 4,481,335, GB 1387076, EP 0583738, U.S. Pat. No. 5,425,904, GB 2350839 and WO 88/02313. These earlier proposals include proposals for modifying the surface of the recycled cured rubber particles by means of de-vulcanising, or by coating with supplementary latex or liquid polymer containing high levels of curing agent.

It is desired to add recycled rubber particles to new rubber compounds. The ability to do this is dictated largely by the particle size of the recycled rubber. Larger particles can be added to a greater volume percent than small particles. However, larger cured rubber particulates adversely affect the physical properties of the resulting compound, in particular tensile strength, tear strength, elongation at break and abrasion resistance. Recycled rubber dust with small particles (e.g. less than 0.25 mm) results in a compound having better physical properties. However, small particles are much more difficult to add and disperse in substantial quantities, at least without seriously sacrificing processing properties such as handling during mixing, extrusion and calendering. There is a great reduction in tack and in uncured green strength of the rubber. Mould flow tends to be poor. Thus, the incorporation of small particle size rubber crumb or dust as a component in new vulcanisable rubber compounds is limited to low levels—not greater than about 12%—for products where physical and dynamic properties are significant.

More recently, our WO 2005/028552 described methods and products in which recycled crumb rubber can be incorporated at high levels into base rubber compositions, resulting in roll-processable materials giving high elastomer performance, by using a low viscosity rubber component such as a liquid rubber effectively as a processing aid; the liquid rubber assists dispersion of the crumb rubber into the base rubber, contacting it intimately and subsequently polymerising into the system so that problems such as blooming, (encountered when using high levels of conventional processing aids for dispersing particles) are avoided. The proposals of WO 2005/028552 represent a significant advance in successfully incorporating cured rubber particles into a rubber matrix so as to give a composition curable to relatively high-performance articles.

However as mentioned above there is an ongoing wish to increase the performance of products relative to the amount of recycled material that they contain. For example, if any one or more of the tensile strength, restitution coefficient or compression set of an elastomer composite containing particulate recycled rubber can be increased for a given level of recycled material, then the way can be opened either to make new kinds of products (because of the improved performance) or to incorporate higher levels of recycled material for a given level of performance. This can be termed an improvement in “incorporability”.

### Our Proposals

We have noted that the treatment of particulate materials for recycling, to modify their surface chemistry and/or topography, can lead to marked improvements in the ability to incorporate the particulate materials into new products, and/or to marked improvements in the properties or performance of such products. This is in relation to polymer-based materials such as resins and elastomers, particularly recycled rubber, particularly cured/vulcanised rubber. Typically they have been rendered into particulate form after being recovered from the end-of-use product concerned. The preferred recycling use of the particulate material embeds it in (or beds it together with) a flowable, e.g. visco-elastic or plastic matrix material such as an uncured or virgin rubber which cures, dries or sets to form a matrix incorporating the dispersed recycled particles, with intimate contact of the matrix material on the surfaces of the particles.

In general terms, our proposed procedure modifies the surface, and particularly the surface chemistry, of the particles without affecting the bulk properties of the material, i.e. without changing the material internally throughout the particle. Various techniques for achieving this so as to enhance the compatibility of a material surface to another material to be contacted with it are known per se. They include any one or more of the following methods:
surface etching, causing free radical formation leading to enhanced chemical reactivity with a contacting material;
ablation of the particle surface, cleaning away surface contaminants and exposing fresh surface;
erosion of the surface so as to increase the surface area and hence its potential for binding or adhesion;
grafting of selected active molecules onto the particle surface;
chemical modification on the surface, e.g. by abstraction and substitution;
deposition of chemically active material onto the particle surface;
increase of wettability by increasing the surface energy of the particle surface, and
polymerising large molecules onto the particle surface.

With a particular view to achieving a treatment of particles that can be carried out conveniently in bulk, we prefer the use of methods in which a mass of the particles is exposed to a medium (liquid or gas), and particularly preferably a gas-phase or plasma-phase treatment because this facilitates full separation of the treated particles from the treatment medium or media, and also lends itself to a continuous or substantially continuous process.

In particular, we have found that the treatment of particles—and particularly polymer particles such as recycled rubber particles—by ionised gas is both convenient to carry out and highly effective in improving the incorporation of the material into a subsequent matrix or binder material, either in terms of the level of incorporation or the performance of the resulting composite. While wet chemical treatments such as chlorination can to some extent improve the performance of the particulate material, we prefer gas-phase treatments such as
plasma treatment;
gas chemical treatment;
ion beam etching;
UV irradiation;
ozone treatment;
gas-phase oxidation.

The most preferred method is a plasma treatment or corona discharge, which generates reactive ionic species in the gas-phase by the use of electric or electromagnetic fields. This can be an essentially dry process. Treatment at sub-atmospheric pressure such as using vacuum plasma technology is preferred, to achieve a volume treatment, although treatment at atmospheric pressure is possible. Plasma treatment may be carried out in any of a variety of gases, but an effective plasma can be formed simply using atmospheric gases and this is highly convenient; we find that it gives a significant level of improvement in the incorporability of treated particulate material such as recycled cured rubber into a matrix material such as a virgin rubber matrix.

Plasma treatment apparatus is already commercially available enabling plasma treatment in vessels or exposure chambers of substantial volume. Relevant types provide for articles to be tumbled in a drum or barrel in the plasma zone to expose them all over. Such technology can be adapted for the present purposes. Substantial volumes of particulate material can be passed into or through such a treatment chamber with exposure to plasma, preferably with agitation.

A preferred mode of treatment is a cold gas low pressure plasma.

In a preferred embodiment of the invention, crumb rubber for recycling is subjected to plasma treatment under agitation in a treatment vessel or zone such as a drum or conduit, in either a batch processing or more preferably a continuous processing mode. Treatment is carried out at an intensity/duration sufficient to enhance the incorporability of the material into a matrix material as described. It may be at ambient or at reduced pressure or vacuum level, the latter being preferred and particularly appropriate to batch-mode processing but also possible in continuous modes.

Treatments as described will improve the incorporability into matrix materials of a whole range of materials as mentioned, including materials which are being used for the first time rather than recycled. Use of the techniques on such “first use” materials is also comprehended herein as an aspect of the invention, but the primary purpose is for the improvement of the recycling of polymeric materials and, in particular, the recycling of vulcanised rubbers.

The known methods for improving recyclability of vulcanised waste have, as mentioned above, suffered from the generally low surface energy of the resulting particulate, leading to its being usable only in products requiring low physical properties except where the level of addition of the particulate is very low.

As will be understood from the above, the preferred embodiment of the present invention treats particulate vulcanised rubber using a plasma treatment, or other gas-phase ionic treatment. We find that this leads to increased surface energy of the particulate surface, leading in turn to improved wetting of the particles corresponding to a higher level of “incorporability” into compatible matrix materials.

Plasma or other surface treatment of powders or particles, including polymeric powders is not in itself a novelty. It is the finding that this procedure can be applied to waste materials, especially certain cured rubbers, and render these extremely useful for re-use, that underlies some of the present proposals.

More than one of the treatments proposed herein may be used in combination. For example a treatment by coating, etching, ablation, grafting or deposition may be used alone to “re-engineer” the particle rubber surface, improving the particles' ability to bond chemically with freshly mixed rubber compound or onto the surface of rubber products during a process of vulcanisation. By enhancing bonding of the rubber particles within a compound or matrix, physical properties characterising the vulcanised compound such as tensile strength, elongation at break, tear strength, abrasion resistance, flex fatigue life and compression set may be improved either individually or in combination.

### Preliminary Recycling Stages

In a recycling procedure, a used or waste product is processed to recover from it a polymeric material, especially a cured elastomer such as a natural rubber, SBR, nitrile rubber or blend thereof, which is in particulate form. Usually a comminution or particle-forming stage is required. This may be applied to waste containing such rubber as a major or only component, such as tyres, flooring, mats, or other product.

For example it is already a practice for waste tyres to be processed at recycling centres where a size reduction or comminution process is carried out, during which steel and fibres are removed. The size-reduced rubber granules are sorted into various sizes, typically from 60 mesh at the fine end to 12 mm at the coarse end, and the rubber granulate is then packaged in bags of various sizes. The sorting process is typically by means of separating and identifying the size by passage through a screen or a number of screens, which typically vibrate.

The granules can be subjected to a plasma field, preferably when they are substantially separate from one another so as better to expose substantially the whole surface of the granule to a plasma-rich environment. This may be achieved when the granules are e.g. floating, fluidised, falling or under agitation. One preferred stage for such treatment is therefore during, immediately before, or immediately after the screening process. A granule can obtain a temporarily airborne state by tumbling in a barrel, it may be vibrated on a bed, or it may be subjected to a controlled fall through the plasma field.

### Preferred Processes

As mentioned, with a view to achieving a treatment of particles that can be carried out conveniently in industry, we prefer proposed methods in which a mass of the particles is exposed to a plasma-phase treatment.

This is an essentially dry process, with easy separation of the treated particles from the treatment medium, and creates a low level of waste.

The following describes preferred modes of implementation of our plasma treatment proposals as applied to the recycling of waste vulcanised rubber.

Plasma treatment of particulate waste vulcanised rubber, to activate the particle surfaces, takes place in a generally enclosed plasma chamber. This enables pressure to be reduced below atmospheric pressure, and/or enables process gas other than atmospheric air to be supplied to provide a controlled process gas atmosphere for the plasma treatment. This is in accordance with known practice in plasma treatment of solids or solid articles. Plasma-generating electrodes are positioned adjacent to the plasma chamber or plasma treatment space, for generating plasma in the process gas between the electrodes, typically by application of an alternating electric field by means of a suitable power source (RF or microwave).

According to one proposal herein, a mass of rubber particles being treated is confined by a separator wall, comprising e.g. a dielectric or insulating material so that it does not destroy the plasma-forming field pattern, and which spaces the mass of particles from one or more plasma-forming electrodes or outer walls of the plasma chamber. Desirably the separator wall defines an inner chamber, to contain the mass of particles, separated by a surrounding space (in two or in three dimensions) from an outer wall, preferably an outer wall which is or comprises one or more electrodes of the plasma chamber.

In a preferred version the separator wall consists of or comprises one or more regions of a gas-permeable structure, e.g. a mesh or other porous material, fine enough to retain the particles being treated while allowing gas to flow through the separator wall in use.

Such a separator wall or inner chamber wall may provide various advantages. Firstly it may prevent particles from approaching too close to, or adhering to, an outer wall or electrode surface. Particularly with small particles, the ionising effect of plasma treatment, combined with the turbulence naturally associated with plasma formation, tends to cause particles to attract and attach to a electrode or outer wall of the chamber. This causes various difficulties, such as
contamination of the chamber wall or electrode, possibly causing chemical damage, or contamination to subsequent product batches, or interference with stable plasma formation;
localised sharp increases in temperature, giving rise to uneven treatment of the particles in general, and in particular the possibility of burning, carbonisation or degradation of those particles affected by a local temperature increase;
blockage or contamination of process gas flow openings masking them by the particles.

By providing a separator wall as proposed, these difficulties can be reduced or avoided. Rubber particles to be treated can be confined to a treatment zone clear of outer walls, electrodes and process gas flow openings, and where plasma can reliably be established.

A separator wall made of a synthetic polymer mesh is a preferred option. Desirably a separator wall extends right around the treatment zone, at least in two dimensions. With a permeable wall this promotes process gas flow in use. An impermeable separator wall or impermeable separator wall portions may be used. These might be e.g. of plastics laminar material, and easier to keep clean in use than a permeable wall, but some supplementary means of providing gas access—either continuous or periodic—is preferred in this embodiment.

It is preferred to provide also a means for cleaning or clearing the separator wall, e.g. during operation, to avoid particles (e.g. charged rubber particles) being retained at the wall and blocking flow through it, or getting over-treated. A relatively moveable cleaning member such as a sweeper blade is one possibility. Additionally or alternatively, a vibration mechanism may be provided to keep the separator wall clear of particles.

According to a further proposal herein, preferably combined with the previous one, the mass of rubber particles is subject to agitation during the plasma treatment, preferably while the treatment plasma is operative in the treatment zone. Such agitation improves uniformity of surface activation in the mass of rubber particles treated by the plasma, by ensuring that most or all particle surfaces are exposed to plasma. Also, when the plasma is not uniform throughout the treatment zone, particles can then move between different regions, avoiding varying levels of exposure through the particle mass. Operational agitation may be by mechanical means and/or by means of gas flow in the treatment zone. A mechanical means of agitation comprising one or more relatively moveable agitating elements (e.g. rotary blades, fins, stirrers or screws) is preferred because it can provide a falling or tumbling movement of loose particles (with consequent surface exposure) without necessarily requiring high-speed movement of the agitator element(s). Consequently it need not seriously disrupt the plasma. A rate of fluidising gas flow sufficient to achieve a similar degree of particle separation may disrupt the plasma. It is also easier and cheaper to arrange mechanical gas flow agitation. One or more agitator elements may be arranged to move (e.g. rotationally) within and relative to a surround wall of the treatment zone (preferably a separator wall or inner chamber wall as described in the first proposal above). Or, one or more agitator elements such as vanes or fins may be formed as part of a surround wall or separator wall which itself moves bodily, e.g. in rotation, to agitate the particle mass during treatment.

The processing temperature in the plasma is selected in accordance with the material to be treated and the need to form stable plasma. Desirably, for treating particulate rubber, the processing temperature in the plasma is not above 100° C., more preferably not above 80° C. and still more preferably not above 60° C. Preferably the processing temperature is at least 30° C. or at least 40° C., to assist plasma formation. These desired conditions are consistent with the use of so-called cold gas plasma, which operates effectively at low pressure or under vacuum. Cold gas plasma use is in itself well understood. Naturally the optimum temperature in each case will depend on various factors, including the type of cured rubber being recycled, the particle size, the treatment pressure and the composition of process gas.

Means may be provided for regulating the treatment temperature in a plasma treatment zone to a desired value. Such means may include one or more conduits for communicating a coolant fluid to and from one or more cooling elements with surface exposed to the treatment zone, e.g. a surface of an agitator mechanism, chamber wall or separator wall. If wished, temperature control may be automated in dependence on a temperature measurement made by a monitoring detector.

Batch processing is preferred, being more easily consistent with the use of low pressure plasma. However various forms of continuous or semi-continuous processing are possible, e.g. by effecting a flow of particles from a supply into and out of an agitated treatment zone at controlled rates, with the masses of particles in the supply and output shielded from the plasma but within the low-pressure zone.

The duration of treatment, like the temperature, depends on the conditions and on the materials. As a rough guide, it is typically between 20 seconds and 5 minutes of plasma exposure. Plasma treatment may be applied to a given particle mass in plural distinct stages, if appropriate. For example, particulate waste rubber often carries surface contamination resulting from the recovery and grinding processes. It is advantageous to apply a preliminary plasma treatment to loosen and vaporise such contaminants. Process gas containing removed contaminants can then be evacuated, before supplying fresh process gas to the treatment chamber to effect the desired surface activation in a further stage of plasma treatment.

The choice of process gas is not critical. The person skilled in plasma treatment using cold gas plasma is well aware that a variety of process gases can be used to make a plasma (glow discharge) having the propensity for activating a rubber surface. We find that oxygen-containing process gases such as air are satisfactory, although this is not limitative.

While the processing methods described above (use of separator wall, agitation) are preferred in relation to recycling of cured particulate rubber, they are also applicable to the treatment of other particulate materials as part of a recycling procedure, especially polymeric materials. They may also be exploited with modes of treatment other than plasma treatment, since it will be understood that the mentioned benefits of surface exposure to treatment, and particle retention in processing, are obtainable with other kinds of processing and materials.

The type of particle to be treated is not particularly limited. With cured rubber, the process is particularly appropriate with particles of size restricted (e.g. by screening) to a size not greater than 0.5 mm, or more preferably not greater than 0.25 mm, because it is with such small particles that the presently-proposed treatment achieves notable improvements in the “incorporability” of the particles into new rubber or rubber-based products.

The cured rubber of which the particles are made may be of any type, e.g. natural rubber, SBR, nitrile rubber, EPDM rubber, chloroprene rubber or any blend of these. It may contain fillers, residues of reinforcements and the like according to its source. As mentioned, recycled rubber from tyres, other automotive components, flooring or mats is suitable. Rubber from such products may be ground into particles either conventionally or cryogenically. Rubber from tyres is usually a blend of NR and/or SBR and/or butadiene rubber.

Following the treatment, the rubber particles with their activated surfaces are preferably passed promptly either to storage or to use. For storage, it is desirable that the activated rubber particles are protected from deactivation of the activated surfaces. This would typically be achieved e.g. by storing without exposure to gas, under vacuum, or under an inert atmosphere such as N₂, to protect the activated surfaces from exposure to contaminants or oxidation, either of which may cause it to return to a passive state and hinder dispersion on re-use.

For use, the treated particulate cured rubber is preferably dispersed in a curable rubber compound, typically a first-use or virgin rubber compound, which is then cured to form new products incorporating the recycled particles in a matrix of newly-cured rubber. The choice of curable rubber composition is not particularly limited. Preferably it is a viscoelastic or plastic material. It may be a rubber selected, e.g. from NR, SBR, NBR, butadiene rubber, butyl rubber, EPDM rubber, polychloroprene rubber, polyisoprene (synthetic NR) or any blend of these with one another or with other rubbers. The curable rubber to form a matrix may be (or comprise) rubber of the same type as in the recycled cured particles, or which relies on a similar curing system.

We have found that by means of plasma treatment as described above, particulate rubber obtained from recycled tyres can be incorporated, at small particle size and at substantial percentages, with good dispersion in a base rubber compound. This can be done without the use of a low viscosity or liquid rubber component as a processing aid to disperse the rubber particles, as proposed in our WO-A-2005/028552. (However such use of a supplementary liquid rubber as a processing aid is a possibility, as described below). Because of the plasma treatment, the dispersion of the cured rubber particles in the curable base rubber is improved. Moreover the dispersion is found to achieve good chemical and physical affinity between the treated particles and the surrounding base rubber. Amounts of other processing aids such as oils can also be reduced or eliminated.

With particulate (crumb) rubber, it is an option in our proposals to use the methods and means described in WO-A-2005/028552, the contents of which are incorporated herein by reference.

The methods of WO 2005/028552 promote the inclusion of high levels of crumb rubber, at low particle sizes and hence good product quality, with maintenance of useful strength and dynamic properties. The low viscosity rubber component used as an aid to dispersion preferably is (or comprises) a curable liquid rubber combined with the curable rubber base which generally is not liquid; they are typically of a visco-elastic consistency; the Mooney viscosity (ML 1+4 @ 100° C.) may be in a general range of from 10 to 105, more usually from 30 to 80, especially of from 30 to 55. Additionally or alternatively the selection of lower viscosity base rubbers can itself contribute to the wetting of a significant proportion of crumb rubber. Additionally or alternatively, a base rubber subject to molecular cleavage, e.g. natural rubber, may be processed (e.g. by the use of one or more peptisers acting on that rubber, and/or by the application of prolonged mixing/heating conditions as known to a skilled person) to produce a low-viscosity component in the base rubber that will contribute necessary wetting of crumb rubber. This may be done before the combination with the rubber particles, e.g. by pre-working of the base rubber or a selected portion thereof.

Novel apparatus and methods for plasma treatment of particles are in themselves independent aspects of the present proposals.

### EXAMPLES

Our experimental verification of these proposals is now described, with reference to the accompanying drawings in which

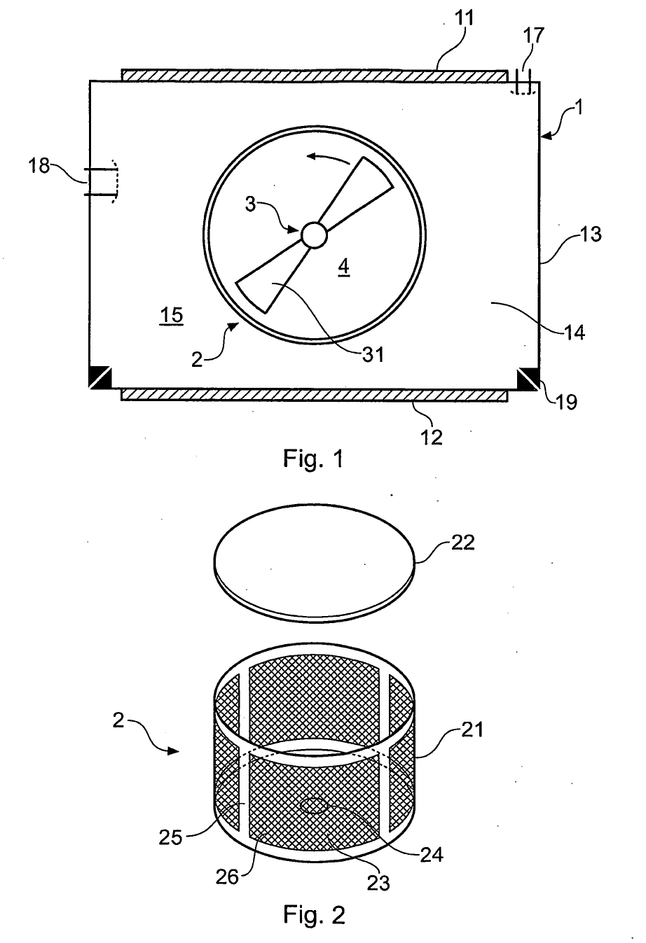

FIG. 1 is a schematic plan view of the disposition of elements in a modified plasma treatment chamber;

FIG. 2 is a perspective view of an inner chamber shown in FIG. 1, to elucidate its structure; and

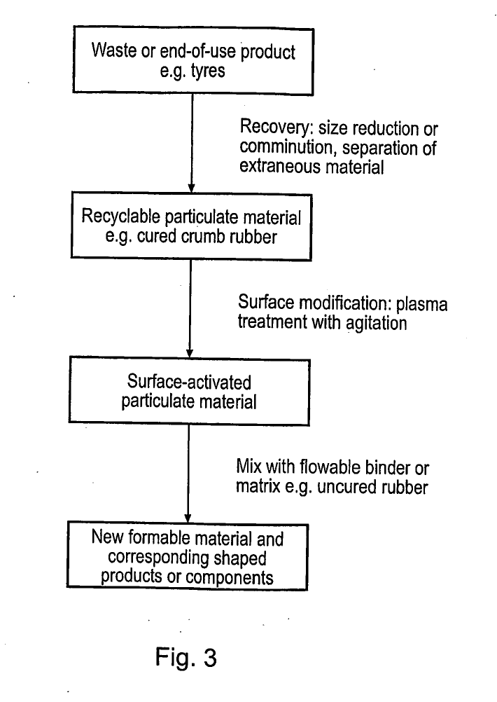

FIG. 3 is a schematic illustration of stages in a recycling process, and is self-explanatory.

### APPARATUS

The illustrated plasma treatment chamber 1 is based on a commercially available cold gas low pressure plasma machine, in this case a PVA Tepla 400 Microwave plasma cleaner. It has a generally rectangular (cuboid) closed treatment chamber, with a front wall forming a door and making a gas-tight seal 19, electrically insulated, around a door opening of the enclosure formed by the other surrounding walls (ends, back, top and bottom). The bottom wall 14 and end wall 13 are designated in FIG. 1. The door carries one electrode 12 for plasma formation, while the metallic wall of most of the rest of the enclosure constitutes the counter electrode 11. Gas flow openings 17,18 with valves and protective mesh screens are provided for the feeding of process gas and the application of vacuum in a known way.

By applying microwave frequency power across the electrodes 11,12 a plasma can be generated to fill a large proportion of the treatment chamber, as well understood by a skilled person.

FIGS. 1 and 2 also show our novel adaptation of the plasma treatment chamber. An annular inner chamber 2 is positioned centrally in the outer chamber. The inner chamber 2 is shown detached in FIG. 2. It is made entirely of non-electrically conductive material. In the present experiment it was made by adapting a plastics household food blender bowl. Side windows 26 are defined by a cylindrical framework of rigid plastics parts 25 extending up around a closed floor 23. A fine nylon mesh 26 is welded or glued to fill each window 26. The chamber top has a detachable plastics lid 22. The floor 23 has a central hole 24 for an agitator element, described below.

The inner chamber 2 is dimensioned and positioned in the outer chamber so that its floor 23 rests a short distance above the floor of the main chamber, and its cylindrical outer wall with the mesh windows 26 is spaced substantially inwardly from the front, back and side walls of the main chamber so that an intervening space 15 is defined all around and above the inner chamber 2, which defines an internal space or treatment zone 4.

An agitator member 3 operates in the internal space or treatment zone 4 of the inner chamber 2. In the experiment, this agitator was also based on the household blender components, being a rotor with two blades 31 inclined propeller-wise and drivable in rotation by an electric motor (not shown) at a speed of about 30 or 40 rpm.

### Materials Used

We worked with recycled particulate or crumb rubber from tyres, screened to a size of 70 mesh.

### Preliminary Experiment

The plasma treatment machine was set to operate under the following conditions:
vacuum: 1.5 millibars (with gas flowing)
process gas: 430 ml O₂ per minute
power: 930W of microwave energy.

Without using the inner chamber 2, rubber particles were spread over the floor 15 of the plasma treatment chamber. The door was then closed and plasma initiated. General temperature within the plasma, once stabilised, was about 60° C.

After trying this several times, it was found that substantial movements of rubber particles took place in the chamber. This is partly due to the turbulence generated as the plasma field stabilises in the chamber. In combination with this turbulence, it seems that particles in close proximity to the door electrode, which become charged early in the treatment, move and attach themselves to the door electrode (cathode). A layer of fine rubber particles gradually accumulates around the edge of the cathode. It was also found that these accumulating attached particles were thermally carbonised, and stuck to the surface. Judging from the condition of the particles, the local temperature at their point of attachment was in the region of 150° C. or more.

We also noted an accumulation of particles on other walls of the treatment vessel, and on the gauzes that cover the gas inlet and outlet ports for vacuum as process gas. After one minute's treatment, there was a substantial dusting of rubber particles over the chamber's inner walls.

### Surface Activity Test

As a convenient rapid measure of surface activation of rubber dust, 10 ml of rubber dust was shaken in 80 ml of water in a glass measuring tube. The tube was then stood for 10 minutes.

With untreated rubber dust, the result of this test was that almost all the rubber particles, although shaken with the water, remained adhered to the side walls of the tube above the water surface. A very small minority of particles settled to the bottom.

The test was then carried out with particles which had been plasma treated lying on the floor of the treatment chamber, as described above. In this case a significant proportion, but still only a minority, of particles settled to the bottom or remained suspended in the water. The remainder (the majority) remained adhered to the measuring tube side wall above the water level as with the untreated particles.

### Use of Inner Chamber

About 1 kg of the 70 mesh rubber particles was placed in the inner vessel 2, with the agitating paddles 31 fitted.

The cover lid 22 was fitted, the chamber closed, and plasma established under the previously-mentioned conditions while rotating the agitating paddles 31 at about 30 rpm. This is a slow speed of rotation, but it created lift and fall of particles in the treatment zone 4.

As in the previous experiment, vacuum was applied for a preliminary period, giving a pressure of about 0.5 millibars, before feeding the oxygen for a further minute to give the operating pressure of about 1.5 millibars as before.

Then, the plasma field was stabilised, the agitating paddles 31 rotating the while, and plasma treatment applied to the particles in the treatment zone 4 for an initial period of one minute. We believe that this initial plasma treatment operated primarily to clean contaminants from the particle surfaces. Accordingly, the plasma treatment was interrupted, the process gas feed stopped and the chamber evacuated to remove volatilised contaminants.

Then, the cycle was repeated (feed oxygen and re-establish plasma while continuing to rotate the agitated blades) and plasma treatment continued for a further one minute to activate the particle surfaces.

On opening the chamber, it was found that all particles had been retained inside the wall of the inner chamber. The door and wall of the main chamber were clear of fouling by particles. Inside the inner chamber 2 the body of treated particles appeared uniform, i.e. there were no carbonised or adhered particles.

When subjected to the simple water shaking test described above, it was found that the overall degree of activation of the surface was markedly superior to that with the floor-treated particles. About half of the particles settled or remained suspended in the water, with a much smaller proportion than before remaining stuck to the tube walls above the water.

Blend with Rubber

In a further test, particles treated by the above-mentioned process were blended with a curable rubber compound, of a type used in tyre manufacture. For experimental purpose and convenience, this was a conventional tyre base compound including various processing aids. Liquid rubber was not used to assist mixing. Nevertheless, we found that the treated 70 mesh crumb rubber could readily be mixed intimately into the curable rubber base, in amounts up to at least 20 wt %. Moreover the resulting compound when cured exhibited dynamic properties which were generally as good as or better than the cured base rubber without the filling of treated recycled crumb rubber. This confirms, as we propose, a high level of physical assimilation and chemical affinity between the base rubber matrix and treated crumb rubber in the compound.

1. A recycling process comprising
obtaining solid polymer material in particulate form, derived from a previous artefact or product;
exposing said polymer particles to a fluid treatment medium which chemically modifies the particle surfaces to provide chemically activated particle surfaces, while maintaining polymer properties in the particle interiors;
combining the surface-activated polymer particles with a flowable binder or matrix material;
curing, drying or setting the binder or matrix material, in intimate contact with the surface-activated polymer particles, to form a body of material incorporating the recycled polymer particles with their surfaces bonded to the cured, dried or set binder or matrix material.

2. A recycling process according to claim 1 in which the solid polymer material is or comprises a cured rubber.

3. A recycling process according to claim 2 in which the fluid treatment medium is a cold gas plasma.

4. A recycling process according to claim 2 in which the cured rubber of the particles is based on any of natural rubber (NR), SBR, NBR, butadiene rubber, butyl rubber, EPDM rubber, polychloroprene rubber, or blends of any of these with another of these, or with another rubber.

5. A recycling process according to claim 2 in which the cured rubber is derived from tyres, mats, flooring or automotive components.

6. A recycling process according to claim 2 in which the particle size of the particulate cured rubber is not more than 0.5 mm, preferably not more than 0.25 mm.

7. A recycling process according to claim 2 in which the matrix material combined with the surface-activated cured rubber particles is an uncured rubber.

8. A recycling process according to claim 2 in which the body of material incorporating the recycled rubber particles constitutes an elastomeric product or component, and is formed by a process including moulding and/or roll-processing.

9. A method of processing a recycled particulate cured rubber material, comprising exposing the cured rubber particles to a plasma treatment in a treatment chamber.

10. A method according to claim 9 in which the cured rubber of the particles is based on any of natural rubber (NR), SBR, NBR, butadiene rubber, butyl rubber, EPDM rubber, polychloroprene rubber, or blends of any of these with another of these, or with another rubber.

11. A method according to claim 9 in which the particle size of the cured rubber is not more than 0.5 mm, preferably not more than 0.25 mm.

12. A method according to claim 9, 10 or 11 followed by combining the plasma-treated rubber particles with a curable matrix or binder material to form a mixed composite in which the matrix or binder material is in intimate contact with the plasma-treated surfaces of the rubber particles, and curing the matrix or binder material.

13. A method according to claim 9 in which, in the plasma treatment, a mass of the rubber particles being treated is confined by a separator wall which spaces the mass of particles from one or more plasma-forming electrodes or outer walls of a plasma chamber in which the plasma treatment is done.

14. A method according to claim 13 in which the separator wall consists of or comprises one or more regions of a gas-permeable structure to allow gas flow through the separator wall during the treatment.

15. A method according to claim 13, including subjecting the mass of rubber particles to agitation during the plasma treatment.

16. A method according to claim 9 in which the plasma treatment includes a first stage of plasma treatment for decontamination, followed by evacuation of contaminant material, and then further plasma treatment for surface activation.
